(19) United States
(12) Patent Application Publication
(10) Pub. No.: US 2006/0256097 A1
(43) Pub. Date: Nov. 16, 2006

(54) Docking apparatus for a pen-based computer

(75) Inventor: Thomas C. Oliver, Windsor, CO (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/128,180

(22) Filed: May 13, 2005

(51) Int. Cl. G09G 5/00

(52) U.S. Cl. 345/179

(57) ABSTRACT

A computer system includes a keyboard having a pen docking portion. A pen includes a memory for storing pen stroke data. The pen downloads the stroke data to a host computer via the keyboard. A pen includes a memory for storing a plurality of pen stroke data, and a transmitter for wireless communication of the stroke data. The wireless communication can be provided such that the pen downloads the stroke data to a host computer directly thereto or using a keyboard having a wireless communication portion. A keyboard may have a wireless transmitter to communicate with a host computer. A pen may be dockable within the keyboard. The pen may have a wireless transmitter for communication with the host computer and may be rechargeable when docked in the keyboard. A pen may have a wireless transmission to the host computer, when undocked from keyboard. When an undocked arrangement, the pen may wirelessly transmit stroke data to the host computer invoked by a sensor which senses the pen's location respect to the sensor, or a physical button depression or other arrangement.

### FIELD OF THE INVENTION

The present invention relates to a pen-based computer. More particularly, the present invention relates to a pen input device for a pen-based computer.

### BACKGROUND OF THE INVENTION

Conventional computer systems, especially computer systems using graphical user interface (GUI) systems, accept user input from a conventional input device, such as a keyboard for entering text, and a pointing device, such as a mouse for operating the graphical user interface. A traditional notion of user interaction is generally in front of a desktop computer or at least sitting within close viewing proximity to a display screen as with laptop computers. Conventional systems are problematic in meeting the challenge of user interaction for new media. The evolution of new media models of computing, such as digital television, digital music, digital movies, have changed the traditional view of the GUI, and the manner in which users can interact with their computers.

The introduction of pen-based computing devices has changed the traditional view of the GUI, and the manner in which users can interact with their computers. While there are a number of designs, a pen-based computing device is generally interacted by way of a writable surface and a pen. The writable surface may be a display surface or a writing pad. Rather than a standard keyboard or mouse interface, the navigation and control of the GUI occurs via the pen. While pen-based computers have been helpful, these known pen-based computers have several drawbacks, which significantly limit their effectiveness. Currently, a design for docking a pen requires cable or dongle. This extra apparatus adds clutter to a user's physical desktop, making pen system less useful. Additionally, the user when “on-the-road” must carry numerous extra components with them, thus creating additional problems.

What is needed is an apparatus and method to support user interaction for an untethered environment with a docketing system of a pen for the new media technologies.

### SUMMARY OF THE INVENTION

The aspects of the present invention pertain to pen input and docketing system for a computer. In one aspect, a computer system includes a keyboard having a pen docking portion. A pen includes a memory for storing pen stroke data. The pen downloads the stroke data to a host computing device via the keyboard. In another aspect, the pen may be rechargeable when docked in the keyboard pen docking portion.

In another aspect, a computer system includes a keyboard having a docking portion for a pen. A pen includes a memory for storing a plurality of pen stroke data, and a transmitter for wireless communication of the stroke data. The wireless communication can be provided such that the pen downloads the stroke data to a host computing device directly thereto or using a keyboard having a wireless communication portion.

In another aspect, a keyboard may have a wireless transmitter to communicate with a host computer. A pen may be dockable within the keyboard. The pen may have a wireless transmitter for communication with the host computing device and may be rechargeable when docked in the keyboard.

In another aspect, a keyboard may have a wireless transmitter to communicate with a host computer. A pen may be dockable within the keyboard. The pen may have a wireless transmission to the host computer, when undocked from keyboard. When in an undocked arrangement, the pen may wirelessly transmit stroke data to the host computer invoked by a sensor which senses the pen's location respect to the sensor, or a physical button depression or other arrangement.

In another aspect, a computer system includes a housing with a docking portion therein for a pen. The pen may transmit data to a processor of the computer system when docked or undocked. The pen may be recharged by the computer system when docked in the docking portion.

The above and other aspects, features and advantages of the present invention will be readily apparent and fully understood from the following detailed description illustrative embodiments in conjunction with the accompanying drawings, which are included by way of example, and not by way of limitation with regard to the claimed invention.

### BRIEF DESCRIPTION OF THE DRAWINGS

FIG. 1 is a functional block diagram of an illustrative general-purpose digital computing environment in which one or more aspects of the present invention may be implemented;

FIG. 2 is a schematic representation of a keyboard system environment according to one or more aspects of the present invention;

FIG. 3 is a functional block diagram of a keyboard system environment shown in FIG. 2 according to one or more aspects of the present invention;

FIG. 4 is a functional block diagram of a pen environment according to one or more aspects of the present invention;

FIG. 5 is a functional block diagram of the keyboard system environment and pen environment shown in FIG. 4 according to one or more aspects of the present invention;

FIG. 6 is a schematic representation of a pen sensing arrangement according one or more aspects of the present invention;

FIG. 7 is a schematic representation of an alternative keyboard system environment according to one or more aspects of the present invention;

FIG. 8 is a schematic representation of an alternative keyboard system environment according to one or more aspects of the present invention;

FIG. 9 is a functional block diagram of an alternative pen environment according to one or more aspects of the present invention;

FIG. 10 is a schematic representation of an alternative keyboard system environment according to one or more aspects of the present invention;

FIG. 11 is a schematic representation of an alternative computing system environment according to one or more aspects of the present invention; and

FIG. 12 is a functional block diagram of an alternative computing environment according to one or more aspects of the present invention.

### DETAILED DESCRIPTION

Illustrative Operating Environment

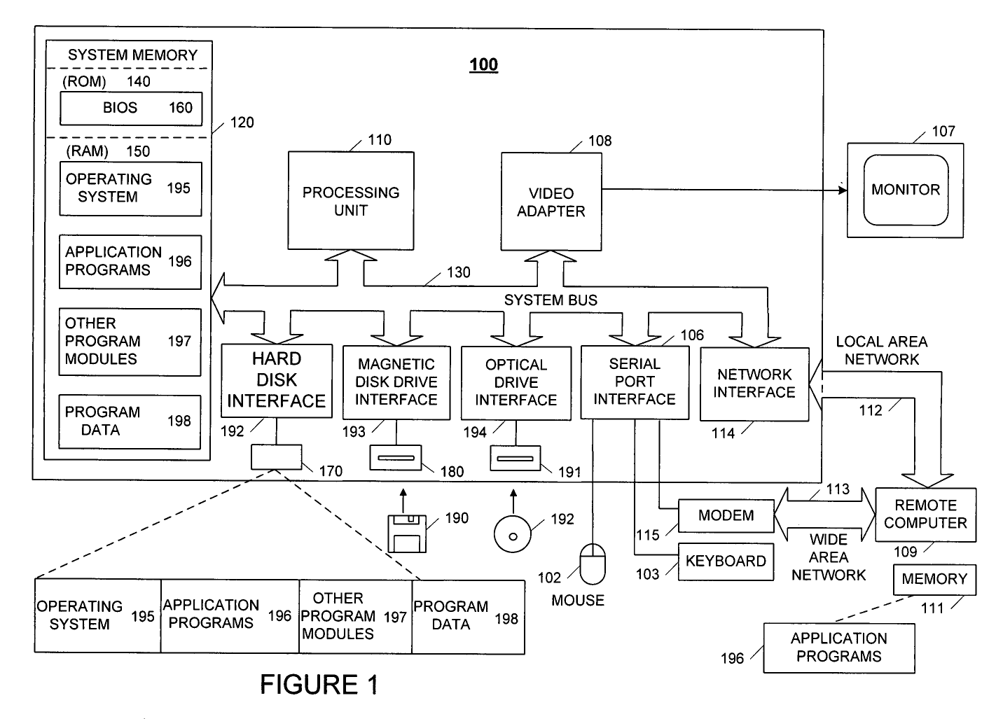

Pen input functionality may be provided by way of a docking system via a keyboard in wired or wireless communication with a keyboard base or host computer system. A keyboard base can include a wireless receiver for the pen stroke data. Alternatively, pen input functionality may be provided by way of a docking system via wireless or wired communication to a host computer system. Various aspects of the present invention may at least be described in the general context of apparatus and computer-executable instructions, such as program modules, executed by one or more computers or other devices. Accordingly, it may be helpful to briefly discuss the components and operation of a general purpose computing environment on which various aspects of the present invention may be implemented. A host computer system can be used for processing data new media technology environment. Such an illustrative host computer system is illustrated in FIG. 1.

Accordingly, FIG. 1 illustrates a schematic diagram of an illustrative general-purpose digital computing environment that may be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192, such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules, and other data for the personal computer 100. It will be appreciated by those skilled in the art that other types of computer readable media that may store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules may be stored on the hard disk drive 170, magnetic disk 190, optical disk 192, ROM 140, or RAM 150, including an operating system 195, one or more application programs 196, other program modules 197, and program data 198. A user may enter commands and information into the computer 100 through input devices, such as a keyboard 200 and a pointing device 102. Other input devices (not shown) may include a microphone, joystick, game pad, satellite dish, scanner, or the like. These and other input devices often are connected to the processing unit 110 through a serial port interface 106 that is coupled to the system bus 130, but may be connected by other interfaces, such as a parallel port, game port, or a universal serial bus (USB). Further still, these devices may be coupled directly to the system bus 130 via an appropriate interface (not shown). A monitor 107 or other type of display device with a display screen is also connected to the system bus 130 via an interface, such as a video adapter 108.

The computer 100 may operate in a networked environment using logical connections to one or more remote computers, such as a remote computer 109. The remote computer 109 may be a server, a router, a network PC, a peer device, or other common network node, and may include many or all of the elements described above relative to the computer 100, although only a memory storage device 111 with related applications programs 196 have been illustrated in FIG. 1. The logical connections depicted in FIG. 1 include a local area network (LAN) 112 and a wide area network (WAN) 113. Such networking environments are commonplace in offices, enterprise-wide computer networks, intranets, and the Internet.

When used in a LAN networking environment, the computer 100 is connected to the local network 112 through a network interface or adapter 114. When used in a WAN networking environment, the personal computer 100 typically includes a modem 115 or other means for establishing a communications link over the wide area network 113, e.g., to the Internet. The modem 115, which may be internal or external, is connected to the system bus 130 via the serial port interface 106. In a networked environment, program modules depicted relative to the personal computer 100, or portions thereof, may be stored in a remote memory storage device.

It will be appreciated that the network connections shown are exemplary and other techniques for establishing a communications link between the computers may be used. For example, the network connections may be wireless communications link. The existence of any of various well-known protocols such as TCP/IP, Ethernet, FTP, HTTP and the like is presumed, and the system may be operated in a client-server configuration to permit a user to retrieve web pages from a web-based server. Any of various conventional web browsers may be used to display and manipulate data on web pages.

Illustrative Keyboard Environments

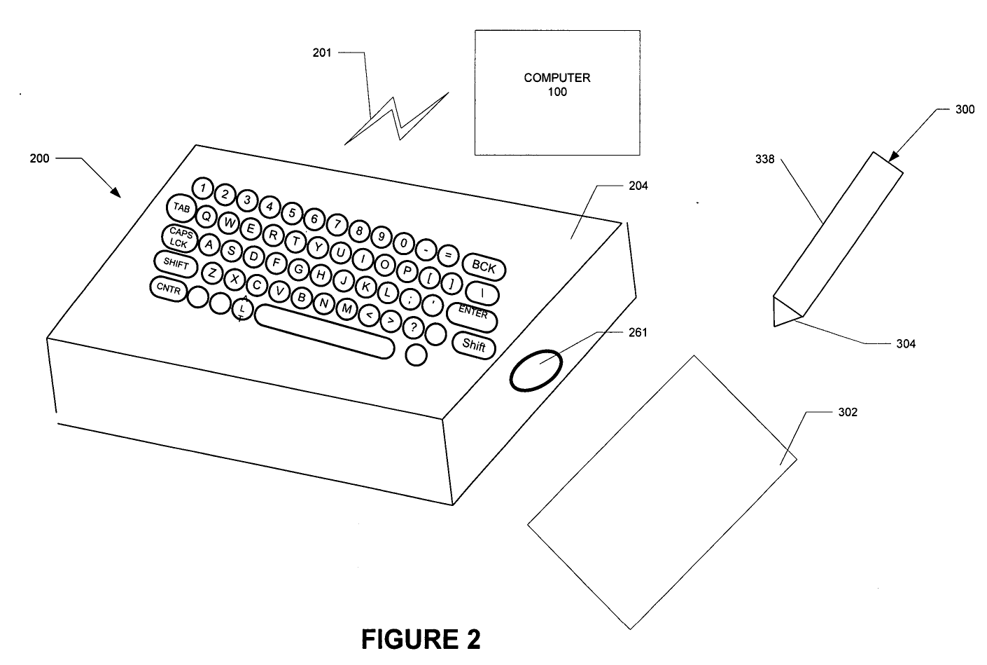

Referring to FIGS. 2-8, in one arrangement keyboard system 200 includes a wireless keyboard base 204 with a docking system of a pen 300. FIG. 2 illustrates one example of a system that can be used in various aspects of the present invention. In one case, pen 300 may be generally embodied as a stroke capture type in which, as writing strokes occur, they are saved within the internal memory of the pen. Pen 300 may be configured to read pen strokes of a user in conjunction with a writing paper 302. The writing paper 302 may have any appropriate a pattern or coatings so that pen 300 can read the x-y position of the pen to generate pen strokes and capture the stroke in memory. In one arrangement, the pen 300 could be implemented in which one end 304 constitutes a writing portion when moved across the paper, pen strokes are recorded. The pen 300 may be equipped with one or more buttons or other features to augment its capabilities. Nevertheless, other pen based systems could be used.

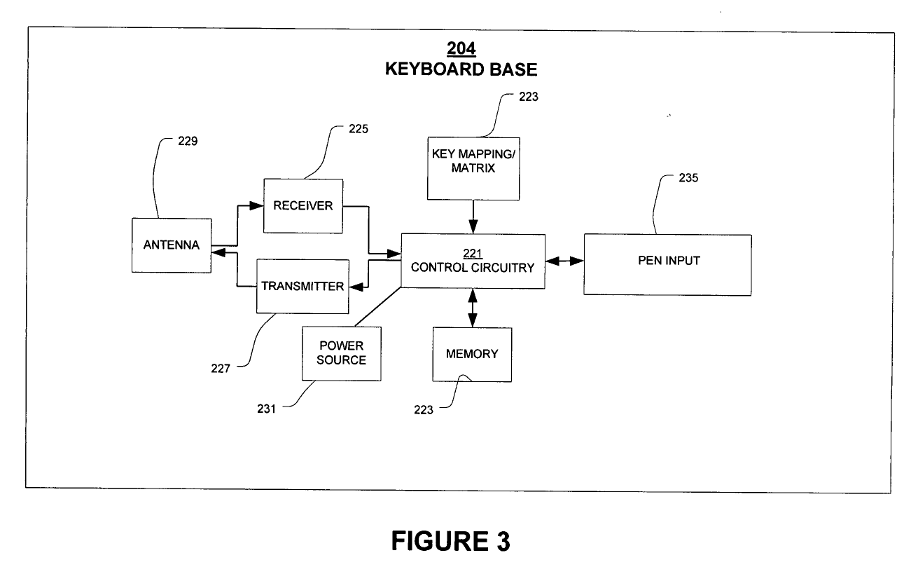

Turning to FIGS. 2 and 3, keyboard system 200 may transmit data to the host computer 100 via a wireless communications connection 201 (see FIG. 2). The wireless connection arrangement provides the user with untethered freedom to use the keyboard system 200 in a new media environment. The keyboard system 200 may include electronic components and software such as, a control circuitry 221, a memory 223, a receiver 225, a transmitter 227, an antenna 229, electric power source 231, and key mapping/matrix 223, and a pen input 235 for the receiving pen stroke data or other data from the pen 300. The electric power source 231 provides the electric power to operate the keyboard system 200 components and other functions. In one arrangement, electric power source 231 may be embodied as a battery electrically connected to the various components of the keyboard system 200. If desired, electric power source may implement one or more features of smart battery technology for communicating battery power capacity to host computer. The keyboard housing 219 (see FIG. 2) encloses the aforementioned internal components of the keyboard system 200, such as the control circuitry 221, the memory 223, the receiver 225, and the transmitter 227. It should be recognized that keyboard housing 219 may be formed of various shapes and of suitable plastic materials. The housing 219 can be molded or otherwise formed with conventional manufacturing methods.

Keyboard base 204 may include hardware and software configured to recognize which key is activated in the key mapping/matrix 223 and process electrical input from the pen input 235. The control circuitry 221 includes one or more microprocessors (not shown) as known in the art for operating on electrical input. Control circuitry 221 is operatively connected to receiver 225, transmitter 227, memory 223, and pen input 235. The memory 223 may be any programmable type in which nonvolatile storage can be electrically erased and reprogrammed. Possible alternatives include flash memory, flash ROM, RAM with battery backup from electric power source 231.

It should be recognized that the terms transmitter, receiver and antenna are used for ease of explanation in that they may embodied in many different alternatives forms. For example, a transmitter and a receiver can be embodied as a transreceiver or a bi-direction communication data port, such as with infrared communications. An antenna can be embodied for receiving or sending radio frequencies. Alternatively, an antenna can be embodied as a lens for infrared communication. Turning to FIG. 3, receiver 225, transmitter 227 and antenna 229 provide a function of allowing the keyboard base 204 to connect wirelessly to the host computer 100 (See FIG. 1) at a proximate distance. The receiver 225 is operatively coupled to the antenna 229 for receiving a wireless communication transmission including pen stroke data from pen 300 or other data. The transmitter 227 is also operatively coupled to the antenna 229 for sending a wireless communication transmission or message, such key scan codes, pen stroke or other data to host computer 100 or other computing device.

It should be recognized that host computer 100 includes a receiver and a transmitter (or a transceiver) operatively coupled to the processing unit 110 via the system bus or serial connection. The wireless connection may include infrared frequencies or radio-controlled frequencies, such as Bluetooth radio-frequency (“RF”) specification and protocols One type of wireless connection may be the widely available communication standards such as, the Infrared Data Association (“IrDA”) specification and protocols, such as IrDA Data or IrDA Control. The IrDA communication protocols provides low-cost, short-range, cross-platform, point-to-point communications at various transfer rates for devices employing the standardize protocol. There are various suppliers of IrDA compatible hardware for transceivers and interfacing software modules. Nevertheless, the wireless connection may radio frequency based. The radio-controlled configuration may include a transmitter 227 and receiver 225 operating at 27 MHz, but other alternative frequencies may be implemented. Further, it is contemplated that keyboard system 200 may have Wi-Fi capability such that it can be communicate via a wireless network using 802.11b protocol to host computer 100 or pen 300. Nevertheless, any appropriate wireless transmission protocol or wireless medium arrangement can be employed to connect keyboard system 200 or pen 300 to host computer 100 for operation, such as a wireless USB protocol.

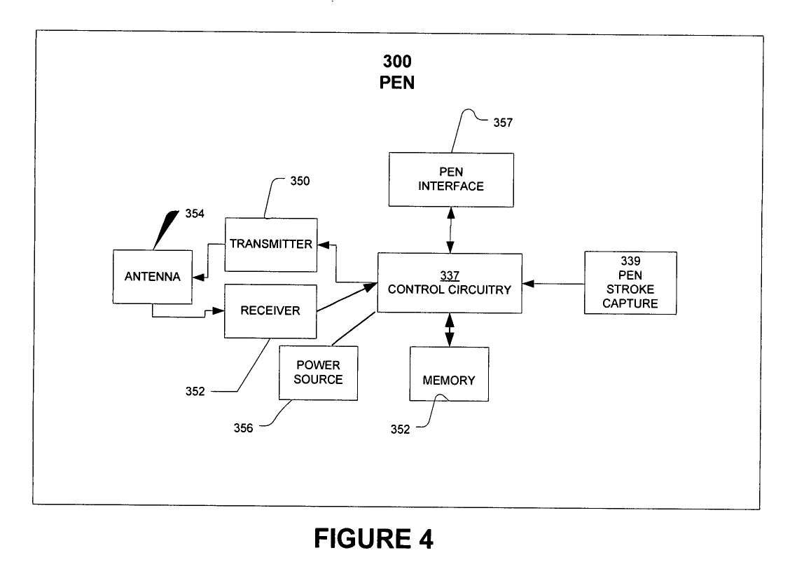

FIG. 4 is a functional block diagram of a stylus or pen environment according to one or more aspects of the present invention. A pen 300 may have a body or housing 338 that may be configured to fit within a user's hand. Body 338 (See FIG. 2) may be formed with conventional manufacturing methods and can be formed of a desired shape with suitable plastic material. In one arrangement, pen 300 may be provided and adapted to interface electrically with a keyboard base 204. In another arrangement, pen 300 may be configured to draw electrical power from keyboard 204 when physically coupled or nested therein. In yet another arrangement, pen 300 including body 338 is adapted to be physically coupled and uncoupled or nestable to provide removability with a keyboard base 204. These features are discussed in detail herein.

Pen 300 includes a control circuitry 337 that is configured with hardware and software which provides for the pen to capture pen stroke data. Control circuitry 337 includes a microprocessor as known in the art for operating on electrical input such as digital data. Control circuitry 337 is operatively connected to a radio frequency transmitter 350, receiver 352, and computer readable memory 352. The memory 352 may be a programmable type in which nonvolatile storage can be electrically erased and reprogrammed. Memory 352 provides storage of pen stroke data captured by pen stroke capture component 339. Pen 300 includes a mobile power source 356 for providing electrical power via one or more batteries and the like. Pen capture component 339 is operatively coupled to the control circuitry 337. Pen capture component 339 includes hardware for capturing the pen strokes in a data format as known by one of the ordinary skill. For example, pen capture component may include optics for receiving images the pattern on the paper 302. Transmitter 350 is also operatively coupled to control circuitry 337 for transmitting signals via an antenna 354. Receiver 352 is operatively coupled to control circuitry 337 for receiving electrical signals from antenna 354. This configuration is useful for transmission of wireless data, such as pen stroke data to keyboard base 204 or host computer 100 via a Bluetooth™ protocol or other arrangement. The signals may be received by the host computer 100, or keyboard base 204 or other electronic equipment, which is enabled to receive and process wireless signals. For example, the wireless signals may be received and processed by an appropriately configured wireless hub.

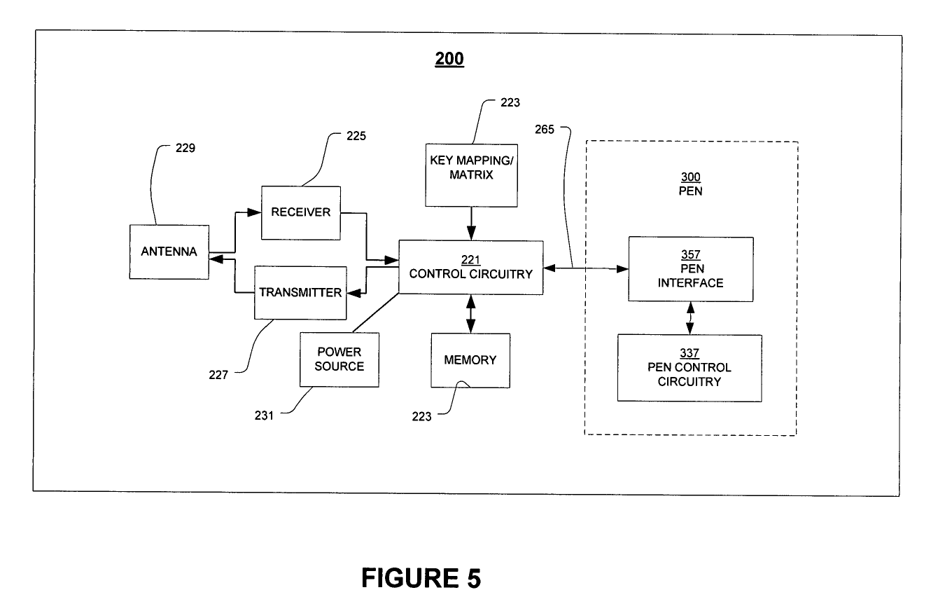

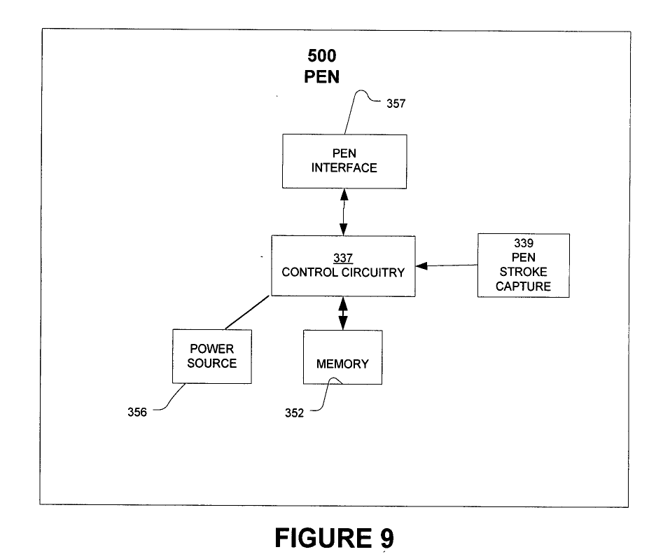

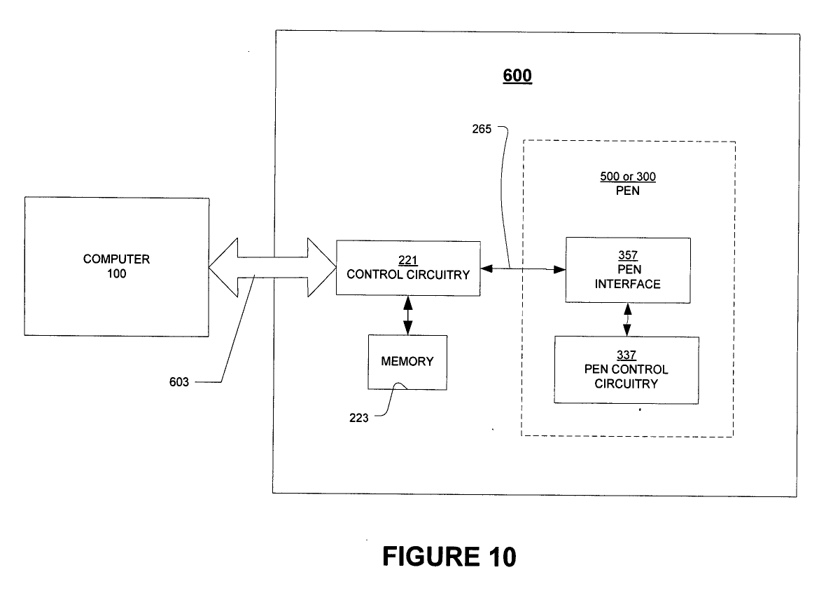

With reference to FIG. 5, in one arrangement of keyboard system 200, pen 300 is docked into the keyboard base 204. Pen 300 may be removably coupled, when docked, via a signal interface connection 265 to provide electrical coupling and physical connections to keyboard base 204 in one docked configuration. In one such interface arrangement, keyboard base 204 may be electrically coupled to pen 300 by way of a bus type arrangement for bi-directional signaling and communications. In a bus type arrangement, data generated at the pen 300 is transferred and processed by the keyboard base control circuitry 221. This arrangement allows for faster processing of generated signals from pen 300. Alternatively, in another signal interface arrangement, keyboard base 204 may be electrically coupled to pen 300 by way of a serial type connection. In these arrangements to provide mateable electrical connections, conventional male and female electrical connectors can be used for physical metal-to-metal contact to transmit electrical data signals. Functionally, when physical mating occurs, a connector of pen 300 is sensed by logic in keyboard circuitry 221. Advantageously, pen stroke data of pen 300 is processed by on-board control circuitry 337 and transferred to the keyboard base circuitry 221. Thus, when the pen 300 is physically coupled to keyboard base circuitry 221, pen stroke data is transmitted by the keyboard base 204 to host computer 100 via the antenna 227 and transmitter 229, rather than transmitter 350 and antenna 354 of pen 300. Thus, transmitter 350, receiver 352 and antenna 354 of pen 300 are optional or can be bypassed by the control circuitry 221. This configuration is shown in FIG. 9, in which pen 500 includes a control circuitry 337, pen stroke capture 339, memory 352, mobile power source 356 and a pen interface 357 as previously described herein. The pen 500 can capture strokes, store them and then transmit the strokes via a wired connection when docked as shown in FIG. 10. Pen 500 has manufacturing efficiencies and increased battery life due to a reduced internal component configuration.

Referring to FIG. 10, in a wired configuration to host computer 100 of a keyboard base 600, data generated by way of a stroke data of pen 300 or pen 500 is transferred by the keyboard base 600 to host computer 100 via a wired connection 603, such as keyboard cord and the like. This stroke data is processed by processing unit 110 for display or other activities. It should be recognized that any conventionally appropriate electrical connectors for electrical signaling configuration may be used for the previously discussed connections. It should be noted that in a wired arrangement of keyboard base 600, a receiver, a transmitter and an antenna are optional. Nevertheless, if provided, the receiver, transmitter, and antenna can be bypassed by the control circuitry 221. In this configuration, reduced manufacturing cost can be more readily obtained by having less internal components, for example. In another advantage, pen 300 or pen 500 may be recharged with the same input/output configuration.

In one example, the wired configuration keyboard base 600 may have a component of a Universal Serial Bus (USB) connection. The USB standard has wide spread use for connecting peripherals to computers. In this example, the control circuitry 221 may include the software to operate with the USB standard. In one embodiment, this Universal Serial Bus can be the Universal Serial Bus-On-the-GO (USB-OTG) standard configured for portable device-to-device communications without a general purpose computer. This implementation is useful in that USB-OTG has low power consumption of about 8 milliamps to preserve the battery operating life. In an USB-OTG implementation, using a topology of host/peripheral, the control circuitry 221 of keyboard base 600 with pen 300 or pen 500 may act as a peripheral device and computer 100 becomes a host device. Further, data transfer with the USB-OTG allows symmetric bi-directional communications between connected devices. Nevertheless, other wired connections are possible to the computer 100, such as PS2 connections.

In one coupling arrangement, referring to FIGS. 4 and 5, pen 300 may include a pen interface 357 which is configured cooperate with signal interface connection 265 of control circuitry 221 of keyboard base 204. For ease of explanation, FIG. 5 shows in dotted lines, pen 300 with control circuitry 337 and the pen interface 357. Pen interface 257 in conjunction with keyboard control circuitry 221 may be embodied in a numbers of formats to provide electrical and logical coupling. In one arrangement, shown in FIG. 2, keyboard base 204 with keyboard housing 219 includes receiving slot 261 formed as cavities or recesses. Receiving slot 261 is designed to receive and retain pen 300 therein. In another arrangement, pen 300 may be slidably attached or otherwise coupled to the keyboard base 204. Receiving slot 261 can enable connection to the keyboard control circuitry 221 by an appropriate connector. While receiving slot 261 is shown on the right side of the keyboard housing 219, the slot 261 may be located on the front side, left side, or other parts of the housing.

In a coupling arrangement shown in FIG. 5, pen 300 electrical power may be drawn from the keyboard power source 231, instead of pen power source 356. This power management configuration is particularly useful when keyboard base 204 is in a wired arrangement with host computer 100. Functionally, when docking occurs, a connector of pen 300 is sensed by keyboard circuitry 221. Electrical power from the power source 356 is temporarily disconnected via a switching arrangement. Advantageously, battery power of the pen 300 is conserved and battery of power source 356 may be recharged with energy from the keyboard's power source. This feature can be implemented in a number of ways. It should be recognized that section 300 may be powered by physical mating with a charging pins. In one arrangement, when the power source 356 is receiving power, the control circuitry 337 may report to the host computer 100, that it is receiving external power. In such arrangement, a visual indication of the charging arrangement may be provided in the form of a graphical icon configured to operate with an appropriate event-driven operating system.

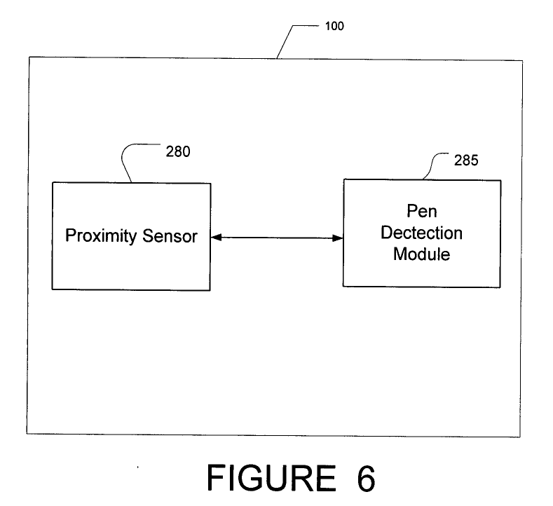

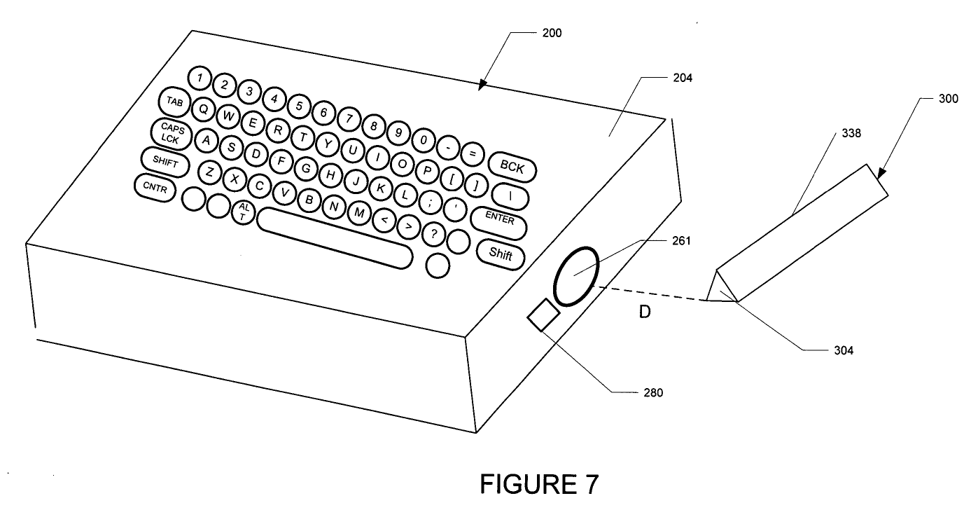

In another aspect of the system environment referring to FIGS. 6-7, the operating software or application software may be configured to anticipate when the pen is heading toward the receiving slot 219 for downloading of data from the pen 300. The data download may be stroke capture data or other stored data. A pen detection module 280 may be a software module which can determine where the pen is with respect to a sensor, such as a proximity sensor 280. This sensing feature provides for a faster download of data, instead waiting for physical abutment of the pen end 304 to a connecting in receiving slot 219 of keyboard base 204.

Referring to FIGS. 6-7, a sensor 280 may be configured to sense the pen tip 302 within a threshold distance range denoted as “D”, such as within 5-20 mm or less from the sensor 280. Nevertheless, other distance ranges are possible for operation. Sensor may be located within the receiving cavity 216, such as in the sidewalls or other location. As shown in FIG. 7, sensor 208 may be located on the side of the keyboard base 204. The sensor 280 may sense signal strength and the signal strength may be a function of distance. In one arrangement, when the pen tip 304 is within the threshold range D, a pen-in-range event may occur. This event indicates that the pen 300 is being used near the sensor 280. Alternatively, this event provides an indication that the user is about the dock the pen 300. Nevertheless, there are many possibilities for designating this type of event for an in-range indication of the pen. The pen-in-range event may then invoke a software process to activate the download of data to host computer 100 or keyboard base 204 wirelessly. For example, a wireless download signal may be invoked. In one example, a Bluetooth™ protocol may be used for communications with pen 300 and host computer 100 or keyboard base 204. Alternatively, when the pen tip 304 is at a distance greater than the threshold range D, then a pen out-of-range event may occur. In such a case, the downloading of data may be interrupted. In another aspect, the pen stroke data or other data storing in memory 352 of pen 300, can be invoked by a user selectable button on pen body 338. Thus, when pen 300 is undocked, a wireless download may be achieved with a Bluetooth™ protocol for communications with host computer 100 or keyboard base 204. Nevertheless, other protocols are possible for use.

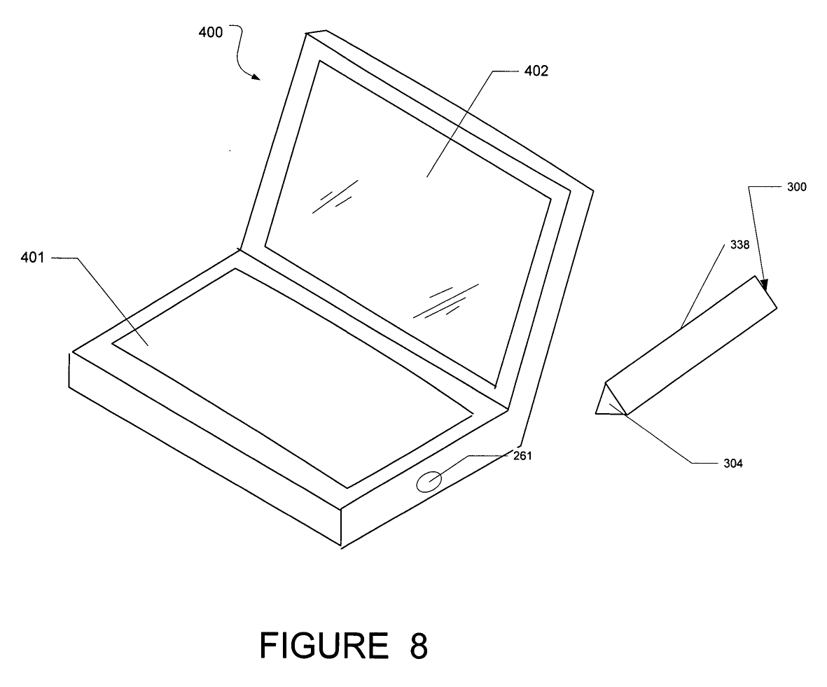

While aspects of the present invention have been described with reference to a standalone keyboard of a desktop type of computer, it will be understood that a clamshell type of computer, such as a notebook computer, may be used without departing from the scope of the invention. In one illustrative example shown in FIG. 8, a computer 400 includes a display surface 402 and a keyboard 401. Display surface 402 has the same functionality and construction as display surface for monitor 107 (see FIG. 1). In this arrangement, the clamshell computer has two housing members or case members for the retaining components, e.g., one housing member for the display screen 402 and the other housing member for the keyboard 401. The docking receiving slot 261 can be mounted on the side surface of the computer 400. While receiving slot 261 is shown on the right side of the keyboard housing 219, the slot 261 may be located on the front side, left side, or other parts of the computer housing.

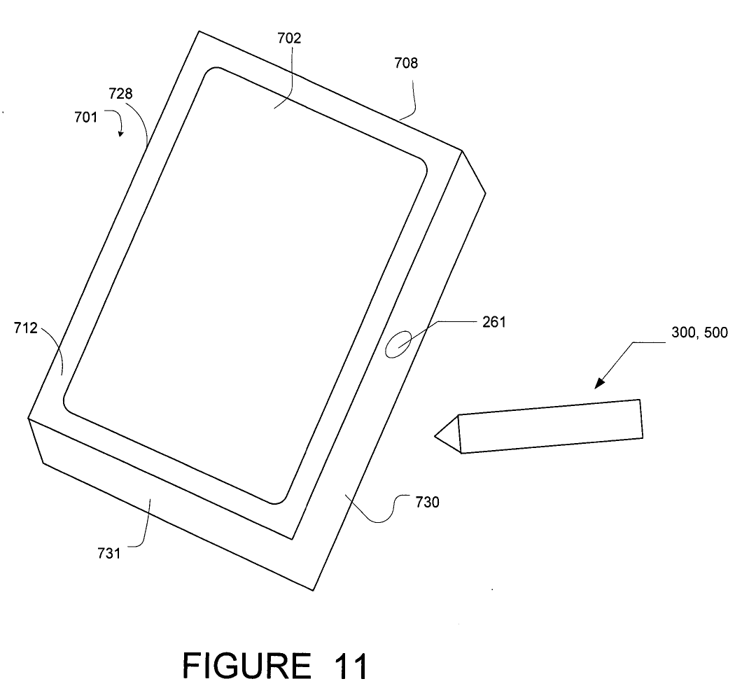

FIG. 11 shows an illustrative computing device 701 which may serve as a host computer that may be used in various arrangements with a pen configuration. Any or all of the features, subsystems, and functions in the system of FIG. 1 can be included in the computing device of FIG. 11. Device 701 includes a display surface 702, e.g., a flat panel display, such as a liquid crystal display (LCD) screen. The computing device 701 includes a computing housing 708 with a front face 712. Computing device 701 may be a tablet type or personal digital assistant, for example. Pen 300, 500 may be used to capture pen strokes. Hence, pen 300 may be used to in a wireless configuration as computing device may be configured with sending a received wireless signals. Pen 500 may be used in a non-wireless configuration such that stroke data transferred when the pen is within the docking receiving slot 261. Nevertheless, pen 300 may be used similar to transfer data as pen 500. The docking receiving slot 261 may be disposed on the computer housing side, such as a left side face 728 or right side face 730 of the housing 708. Docking receiving slot 261 could be mounted on the bottom face 731 or the top face of the housing 708.

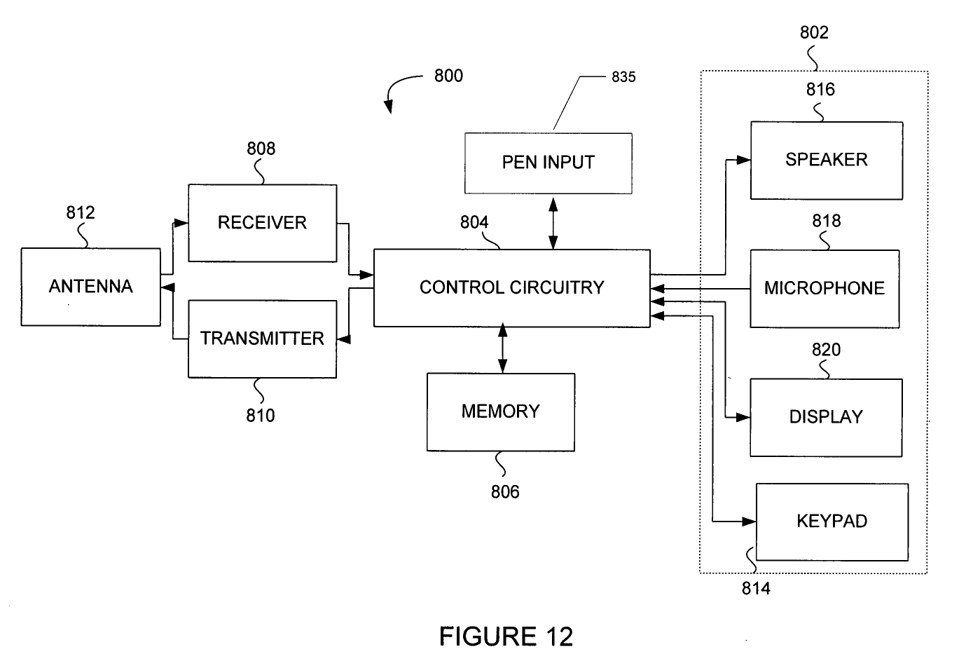

It will be understood that a computing device, such as a mobile telecommunications device, for example, a cellular phone with a display and microprocessor or a smart phone, may be used without departing from the scope of the invention. FIG. 12 illustrates a schematic diagram of an exemplary wireless mobile communications environment that can be used to implement various aspects of the present invention. In FIG. 12, a cellular phone device 800 may include electronic components and application programs including a user interface 802, a control circuitry 804, a memory 806, a receiver 808, a transmitter 810, an antenna 812 and pen input 835. A pen input 835 is configured similar to pen input 235 (See FIG. 3) for receiving pen stroke data or other data from the pen 300 or pen 500. User interface 802 is a portion of the cellular phone device 800 that provides audio and visual signals to a user. The user interface 802 is operatively connected to the control circuitry 804. The user interface 802 may include a speaker device 816, a microphone device 818, a display device 820, and a keypad or keyboard 814. The speaker device 816 provides audible signals to user. The microphone device 818 receives audio input from the user and converts the signals into the appropriate format for the control circuitry 804 to use the signals. The display device 820 provides visual signals to the user in the form of alphanumeric characters, colors or graphical symbols. The display device 820 may be a device used in wireless communication devices, such as a liquid crystal display. The control circuitry 804 may include a microprocessor (not shown), and digital signal processor (not shown) for use on wireless networks. Also control circuitry 804 may include software and network interface software that facilitates cellular phone 800 interfacing to a wireless communications network (not shown).

Alternate combinations of various aspects of the keyboard system arrangements; either alone or in combination with one or more elements have synthetic effects to improve user interaction for pen-based computing and/or efficiency of operation. In one arrangement, a wireless keyboard base unit 204 with a key configuration may have a wireless transmitter to communicate with host computer 100. A wireless pen 300 may be dockable within the keyboard base unit. The pen 300 may have a wireless transmitter to communicate with the host computer 100 and may be rechargeable when docked in the keyboard base unit 204.

Yet another example includes a wireless keyboard base unit 204 may have a wireless transmitter to communicate with host computer 100. A wireless pen 300 may be dockable within the base unit 204. The pen 300 may have a wireless transmission to the host computer 100, when removed from the base unit 204. When in a removable or undocked arrangement, the pen 300 may wirelessly transmit stroke data to host computer 100 invoked by a proximity sensor 280 which senses the pen's location respect to the sensor, or a physical button depression or other arrangement. The pen 300 can be recharged when docked in the base unit 204.

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations.

What is claimed is:

1. A computer system, comprising:
a keyboard having a pen docking portion; and
a pen having a memory for storing a plurality of stroke data; wherein the pen downloads the stroke data to a host computer via the keyboard.

2. The computer system in accordance with claim 1, wherein the pen includes a wireless transmitter for downloading the stroke data.

3. The computer system in accordance with claim 1, wherein the keyboard is configured to transmit the stroke data to the host computer via at least one of a Bluetooth protocol, WiFi protocol, and wireless USB protocol.

4. The computer system in accordance with claim 1, wherein the keyboard includes a wireless receiver, the wireless receiver being configured to receive wireless signals, including the pen stroke data from a wireless transmitter of the pen.

5. The computer system in accordance with claim 1, wherein the pen includes a mobile power source, the mobile power source is recharged when the pen is disposed within the docking portion.

6. The computer system in accordance with claim 1, wherein the keyboard includes a proximity sensor for sensing the pen for transmission of the stroke data.

7. The computer system in accordance with claim 1, in which the pen docking pen portion includes a receiving slot adapted to substantially enclose the pen therein.

8. The computer system in accordance with claim 1, wherein the keyboard includes a wire connection to transmit the pen stroke data to the host computer.

9. A computer system comprising:
a keyboard having a docking portion for a pen; and
a pen having a memory for storing a plurality of stroke data, and a transmitter for communication of the stroke data; wherein the pen downloads the stroke data to a computing device.

10. The computer system in accordance with claim 9, wherein the pen is configured to download the stroke data to the host computer via a Bluetooth protocol.

11. The computer system in accordance with claim 9, wherein the pen includes a mobile power source, the mobile power source is recharged when the pen is disposed within the docking portion.

12. The computer system in accordance with claim 9, wherein the keyboard includes a sensor for sensing the vicinity of the pen with respect the sensor so as to initiate transmission of the stroke data to the computing device.

13. The computer system in accordance with claim 12, wherein the sensor is disposed in the docking portion.

14. The computer system in accordance with claim 12, wherein the pen is configured to cease transmission of the stroke data responsive to when the pen is out of the vicinity of the sensor.

15. The computer system in accordance with claim 9, wherein the computing device further comprises a case member and a display attached to the case member.

16. A computer system comprising:
a housing;
a processor within the housing;
a docking portion for a pen, the pen having a memory for storing a plurality of stroke data, in which the docking portion is disposed in the housing and is configured to receive the stroke data, the stoke data for processing with the processor.

17. The computer system in accordance with claim 16, wherein the computer system comprises a mobile telecommunications device.

18. The computer system in accordance with claim 16, wherein the housing includes a sensor for sensing the vicinity of the pen with respect the sensor so as to initiate wireless transmission of the stroke data to the processor.

19. The computer system in accordance with claim 18, wherein the pen is configured to cease transmission of the stroke data responsive to when the pen is out of the vicinity of the sensor.

20. The computer system in accordance with claim 16 wherein the pen transfers the stroke data when disposed within the docking portion.
